(19) United States
(12) Patent Application Publication
(10) Pub. No.: US 2007/0034642 A1
(43) Pub. Date: Feb. 15, 2007

(54) Mold Powder Feeder

(75) Inventor: Stevens P. Pendleton, Ramsey, NJ (US)

Correspondence Address: NORRIS, MCLAUGHLIN & MARCUS, P.A., 875 THIRD AVE, 18TH FLOOR, NEW YORK, NY, 10022, US

(73) Assignee: VAC-U-MAX, Belleville, NJ (US)

(21) Appl. No.: 11/458,457

(22) Filed: Jul. 19, 2006

Related U.S. Application Data
(60) Provisional application No. 60/701,327, filed on Jul. 21, 2005.

(51) Int. Cl. B67D 5/08; B05B 7/00

(52) U.S. Cl. 222/56; 222/64; 222/630; 222/637

(57) ABSTRACT

An apparatus for dispensing granular material, such as flux powder to a mold for continuous casting of metal, has an intermediate chamber, a dispensing hopper, and a conduit communicating the interior of the chamber to the interior of the hopper. The conduit has a rotatable auger running through its length, the auger reaching from within the interior space of the chamber into the interior hopper for transferring material from the chamber into the hopper. A dispensing line communicates with a bottom of the hopper at a transfer point for receiving material from the hopper and dispensing the material toward a dispensing end of the line. Pressurized air is supplied to the line, upstream of the transfer point, and a sealing cap is provided for actuating into sealing engagement with a hopper end of the conduit. A second inlet for pressurized air is provided such that air may be supplied directly into the hopper above the fill line. An automatic control processor links the various components, and provides for sequential operation. The material is conveyed batch-wise from the chamber into the hopper, and is not dispensed into the line until the chamber access has been sealed, thus preventing backflow into the chamber.

### BACKGROUND OF THE INVENTION

1. Field of the Invention

The present invention relates to an apparatus for holding, conveying and dispensing a fine powder. More particularly, the invention relates to an apparatus for use in dispensing a mold powder or flux to the top of a molten slab being cast in a continuous casting operation.

2. Discussion of the Prior Art

In the steel manufacturing industry, particularly with respect to continuous casting operations, it is the practice to add a flux, in the form of a powder, to the top of the molten slab as it is poured into the mold. Because the addition of the mold flux powder by the operator takes the operator away from the primary casting operation, it is desirable to automate the dispensing of the powder into the mold, or to at least provide a system which runs automatically upon a simple command from the operator.

U.S. Pat. No. 6,474,398 B1 to Schoner et al teaches an apparatus for dispensing mold flux powder, comprising a source for granular mold flux, a means for feeding and delivering the flux from an intermediate hopper to the top of a slab being cast. The delivery apparatus has at least one tube assembly, and conveys the flux by way of an inline air pump. A flow rate mechanism, such as a pinch valve, is present, which varies the volume of air through the tube assembly, and thus controls the amount of flux delivered. The drawback of this system is the reliance on an inline air pump, such as a venturi jet, as the sole means of conveyance from the intermediate hopper. The mold flux is characterized by a high dusting factor, and such dust tends to clog and possibly disable the inline air pump. Furthermore, the dust and powder may back up into the intermediate hopper, thus interfering with the continuous flow of flux to the mold.

U.S. Pat. No. 4,084,626 teaches an apparatus for automatic filling of containers according to net weight. Stations receive conveyably from bulk storage a loose and flowable dry particulate material, which is measured out in an adjustably predetermined net weight amount into a net weight receptacle. The material is then dispensed into an evacuated container such as a bottle. A bulk storage transport assembly transfers the material from a bulk storage source to a staging chamber by way of a screw conveyor. The filling of the staging chamber is continuous and is maintained at a constant level by way of a photoelectric fill level detector.

### SUMMARY OF THE INVENTION

An apparatus for dispensing granular material, such as flux powder to a mold for continuous casting of metal, has an intermediate chamber, a dispensing hopper, and a conduit communicating the interior of the chamber to the interior of the hopper. The conduit has a rotatable auger running through its length, the auger reaching from within the interior space of the chamber into the interior hopper for transferring material from the chamber into the hopper. A dispensing line communicates with a bottom of the hopper at a transfer point for receiving material from the hopper and dispensing the material toward a dispensing end of the line. Pressurized air is supplied to the line, upstream of the transfer point, and a sealing cap is provided for actuating into sealing engagement with a hopper end of the conduit. A second inlet for pressurized air is provided such that air may be supplied directly into the hopper above the fill line. An automatic control processor links the various components, and provides for sequential operation. The material is conveyed batch-wise from the chamber into the hopper, and is not dispensed into the line until the chamber access has been sealed, thus preventing backflow into the chamber.

### BRIEF DESCRIPTION OF THE DRAWINGS

FIG. 1 is a perspective view of the invention.

FIG. 2 is a schematic view of the invention.

FIG. 3 is a schematic view of a different embodiment of the invention.

### DETAILED DESCRIPTION OF THE INVENTION

The invention will be described with respect to the dispensing of a mold powder for use in continuous casting operations. However, it should be clear that the apparatus is independent of the casting operation itself, and so can be used to dispense any type of granular compound for any purpose.

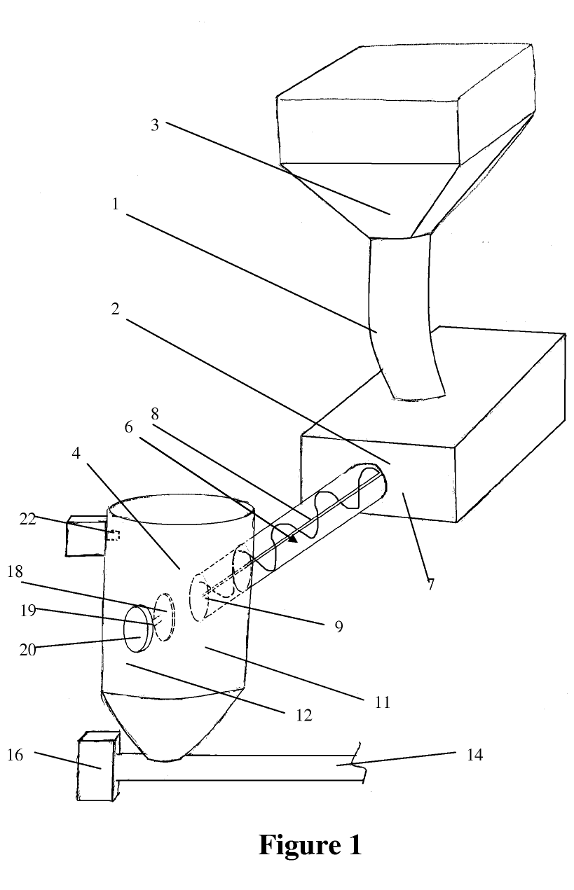

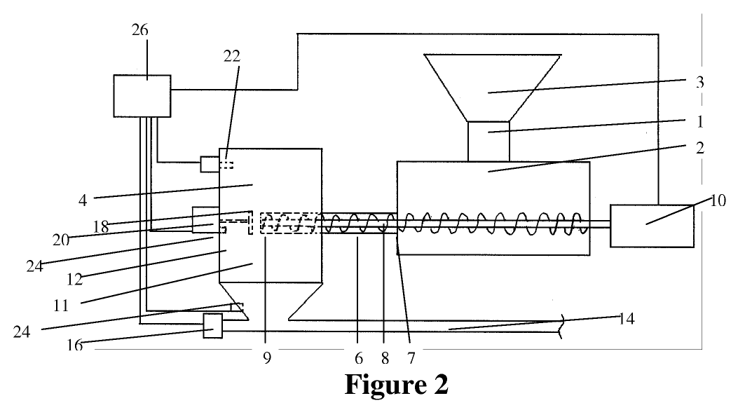

As shown in FIGS. 1 and 2, the powder is conveyed, preferably by gravity, through a conduit 1, to an intermediate chamber 2. The feed to the intermediate chamber 2 is most conveniently taken gravitationally from a surge hopper 3 which itself receives and holds the powder from a bulk source, not shown. However, any means may be used for providing feed to the intermediate chamber. The powder is conveyed batch-wise from the intermediate chamber 2 to a dispensing hopper 4, by way of auger conduit 6. The conduit 6 is a tube having a rotatable auger or screw conveyor 8 therein. The conduit 6 runs from a side 7 of the chamber and opens into the dispensing hopper 4, preferably projecting 9 into the interior of the hopper, towards the center thereof to provide better powder distribution therein. The auger runs preferably from a point at or near the hopper end 9 of the conduit, through the length of the conduit, and then into the interior 11 of the chamber, preferably extending laterally across the interior to or near the opposite interior side 12 of the chamber. The auger is rotated by way of an external motor 10, and optionally a drive shaft, known in the art, for example as set forth in U.S. Pat. No. 4,084,626.

The bottom portion of the hopper 4 has a conical or other converging shape for directing the powder gravity-wise into a dispensing line 14. The dispensing line leads to a dispensing end adjacent the application area for the powder into the mold. Any suitable dispensing means may be fixed to the end for applying the powder, such as a spray nozzle, manifold, etc. To convey the powder through the dispensing line toward the dispensing end, pressurized air is blown through the line toward the dispensing end. In order to avoid the prior art problems associated with inline air pumps, an air pump 16 is provided upstream of the location at which the bottom of the hopper opens into the dispensing line 14.

In order to prevent the additional problem of backflow, caused by the pressurized air flow, of powder back into the intermediate hopper and through the conduit into the chamber, a sealing mechanism is provided. A sealing cap 18, preferably in the form of a disk bearing a suitable sealing gasket, is formed to sealingly close against the hopper end 9 of the conduit 6. The sealing cap 18 resides on an actuating arm 19 operated by an actuating means 20. In the illustrated embodiment, the actuating means is an air cylinder coupled to an air-operated solenoid, which is actuated electronically, preferably by a computer processor. The air cylinder is located externally of the hopper, with its arm reaching through the hopper wall into the interior thereof, through a sealed opening which allows for sliding of the arm therethrough. The air cylinder extends the arm, forcing the cap to engage and seal the end of the conduit. It can be seen that while an air cylinder arrangement is convenient, any means may be used to actuate the sealing cap.

In addition to the upstream air pump 16, an additional pressurized air supply means may be provided in a preferred embodiment. Such additional air supply is provided via an inlet 22 directly into the hopper, at a point about the fill line (described below). Once the conduit is closed by way of the sealing cap, the providing of pressurized air into the hopper, combined with the simultaneous providing of air via the upstream pump to the dispensing line itself, results in a continuous flow of powder out of the hopper and through the dispensing line. The additional hopper air supply means 22 also acts to prevent backflow of powder from the dispensing line back into the hopper. Of course, backflow into the chamber is prevented by way of the sealing cap.

A computer processor or other electronic process control means 26 is provided for coordinating the various actions of the apparatus. Suitable computer software is provided for operating the various parts of the apparatus, and controlling the timing and sequence. An automatic fill detector 24, such as a photoelectric level control shown in U.S. Pat. No. 4,084,626, is provided in conjunction with the hopper. Such a device acts to detect a preferred level of powder within the hopper, and may be any suitable device. The fill line is chosen as a vertical point at or below the bottom of the conduit end. When the fill line is reached, the detector 24 sends a signal to the control means 26. The control means 26 then sends appropriate signals, sequentially, and preferably in close succession: to the auger motor to stop the turning operation, to the seal cap actuator means to seal the end of the conduit, and to the upstream air pump and the hopper air supply means to begin supplying air in order to convey the powder through the dispensing line. When the detector 24 or a second detector detects that the hopper has been emptied of powder, or that the supply of powder has decreased to a certain threshold level, a signal is sent to the CPU to reverse the previous instructions and operations. The air pumps are disengaged, the seal cap is withdrawn, and the auger resumes rotation.

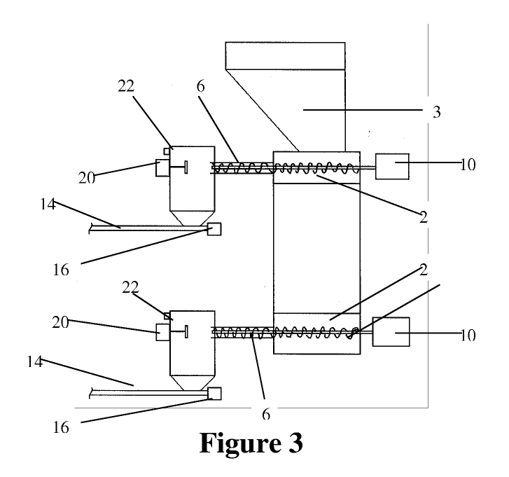

An additional embodiment is described, wherein multiple apparatus may be linked to common powder source in order to simultaneously service several casting molds. As shown in FIG. 3, a second chamber of a second apparatus is located beneath a first chamber of a first apparatus. The first and second apparatus are essentially identical, and of course, further apparatus may be linked in a similar fashion. The first chamber opens at its bottom to gravitationally feed the second chamber. Because of the unique arrangement of the invention whereby backflow of the powder is avoided, a multiplication of apparatus, linked via the chambers, may be provided, secure in the knowledge that a malfunction in one setup will not affect the others. The chambers of the multiple apparatus may be linked in other ways, though for the above reasons it is preferred to avoid pneumatic linkage. If it is necessary to link multiple chambers located in an essentially horizontal plane, such that gravitation transfer of feed is not possible, an auger conduit may be used to communicate the chambers, situated so as not to interfere with the auger conduit of the first chamber communicating with the hopper. Other gravitational or mechanical means of linking multiple chambers may also be realized by those skilled in the art.

In addition to the apparatus described above, the invention also covers a method of dispensing granulated material according to the steps set out above, which are preferably performed in conjunction with said apparatus. In particular, the method for dispensing granular material, comprises the steps of, in order:

(a) providing granular material in an intermediate chamber,

(b) conveying the material from the chamber to a dispensing hopper through a conduit via a rotatable auger,

(c) sealing the conduit,

(d) conveying the material from the hopper into a dispensing line,

(e) dispensing the material through the dispensing line toward a dispensing end thereof by way of pressurized air supplied to the line, upstream of a transfer point between the hopper and the line.

In a preferred embodiment, the method also comprises providing pressurized air into the interior of the hopper above a material fill line, simultaneous with step (e). As step (b)(i) may also be provided between steps (b) and (c), which is the step of discontinuing the conveying of material according to step (b). This step (b)(i) is preferably effected after the detection of the material fill level to a predetermined threshold.

As set forth above in connection with the description of the apparatus, the method also provides for a sequential linking of steps, preferably by way of an automated control processor. Accordingly, the material is transferred from an intermediate chamber to a dispensing hopper by way of a rotating auger, driven by way of a drive motor. When the fill level is detected at a certain predetermined level, the drive motor is discontinues the rotation of the auger—preferably this is performed automatically by way of a signal sent from the fill level detector, though certainly the level detection and motor operation can be performed manually as well. Immediately after the cessation of auger rotation, the conduit connecting the chamber and the hopper is sealed, again preferably by way of an automatic means such as an air cylinder and piston arrangement actuated pneumatically, for example by way of a solenoid. The actuating step is preferably initiated by a signal associated with the fill level detection. Immediately after the sealing step, air pressure is provided to the dispensing line, which is itself in fluid communication with the hopper. The air pressure, applied at the transfer point, and preferably additionally into the interior of the hopper, is also preferably actuated by a processing signal. When the level of the material in the hopper is detected at a predetermined low or empty level, or for example after a predetermined time period, the process steps are reversed. The air pressure for dispensing is discontinued, the conduit is unsealed, and the auger rotates again to bring new material into the hopper.

What is claimed is:

1. An apparatus for dispensing granular material, comprising: an intermediate chamber, a dispensing hopper, a conduit communicating the interior of the chamber to the interior of the hopper, the conduit having a rotatable auger running therethrough, the auger reaching from within the interior space of the chamber into the interior hopper for transferring material from the chamber into the hopper, a dispensing line communicating with a bottom of the hopper at a transfer point for receiving material from the hopper and dispensing the material toward a dispensing end of the line, a first means for supplying pressurized air to the line, upstream of the transfer point, a sealing cap for actuating into sealing engagement with a hopper end of the conduit.

2. The apparatus of claim 1, further comprising a second means for supplying pressurized air into the hopper, above a predetermined upper fill level.

3. The apparatus of claim 1, further comprising a means for actuating the sealing cap.

4. The apparatus of claim 3, wherein the means for actuating the sealing cap comprises a piston arm connected to the sealing cap, the piston arm being connected to a piston residing within a cylinder.

5. The apparatus of claim 4, wherein the cylinder and piston comprise an air cylinder residing externally of the hopper, and the piston arm passes through the hopper wall by way of a sealed opening.

6. The apparatus of claim 1, wherein the conduit and auger therein extend into the interior of the hopper.

7. The apparatus of claim 1, further comprising a fill level detector for detecting when a level of material in the hopper reaches certain predetermined levels.

8. The apparatus of claim 7, further comprising an automatic control processor linked to the fill level detector, an auger motor which causes the auger to rotate, a first air pump which provides pressurized air to the dispensing line, and an actuating means for actuating the sealing cap against the conduit end,

9. The apparatus of claim 8, wherein the control processor comprises means for receiving a signal from the fill level detector that the material in the hopper has reached a first predetermined fill level, means for sending a signal to the auger motor to cease rotating of the auger, means for sending a signal to the actuating means to actuate the sealing cap into a sealing engagement against the conduit end, means for sending a signal to the first means for supplying pressurized air to begin providing pressurized air into the dispensing line, means for receiving a signal from the fill level detector that the material in the hopper has dropped to a second predetermined fill level, means for sending a signal to the first air pump to cease providing pressurized air, means for sending a signal to the actuating means to withdraw the sealing cap, and means for sending a signal to the auger motor to commence rotating of the auger.

10. The apparatus of claim 9, further comprising a second means for supplying pressurized air into the hopper above a predetermined upper fill level, the second means being linked to the processor, and means for sending signals to the second means for supplying pressurized air coinciding with said signals being sent to the first means for supplying pressurized air.

11. A method for dispensing granular material, comprising the steps of, in order:
(a) providing granular material in an intermediate chamber,
(b) conveying the material from the chamber to a dispensing hopper through a conduit via a rotatable auger,
(c) sealing the conduit,
(d) conveying the material from the hopper into a dispensing line,
(e) dispensing the material through the dispensing line toward a dispensing end thereof by way of pressurized air supplied to the line, upstream of a transfer point between the hopper and the line.

12. The method of claim 11, further comprising providing pressurized air into the interior of the hopper above a material fill line, simultaneous with step (e).

13. The method of claim 11, further comprising a step (b)(i), between (b) and (c), of discontinuing the conveying of material according to step (b).

14. The method of claim 13, further comprising a step of detecting a material fill level in the hopper and sending a signal to effect step (b) when the fill level reaches a predetermined level.
